(19) United States
(12) Patent Application Publication
(10) Pub. No.: US 2006/0249386 A1
(43) Pub. Date: Nov. 9, 2006

(54) Use of an osmotic pump to create a flowing reference junction for ionic-activity sensors

(76) Inventors: Michael M. Bower, Wareham, MA (US); Lauren M. Catalano, Wrentham, MA (US); John P. Connelly, Foxboro, MA (US); Stephen B. Talutis, Milton, MA (US); Daniel G. Tower, Wrentham, MA (US); Brian J. Bischoff, Red Wing, MN (US)

Correspondence Address: FOLEY HOAG, LLP;PATENT GROUP, WORLD TRADE CENTER WEST, 155 SEAPORT BLVD, BOSTON, MA, 02110, US

(21) Appl. No.: 11/122,469

(22) Filed: May 5, 2005

(51) Int. Cl. G01N 27/26

(52) U.S. Cl. 204/433; 204/400

(57) ABSTRACT

In an ionic-activity sensor, an osmotic pump drives a reference-cell electrolyte to flow through an interface with the solution to be measured. This minimizes contamination of the reference cell by that solution. The driving force results from expansion of an electrolytic-agent reservoir into which solvent from a solvent reservoir diffuses through a semi-permeable membrane. The electrolytic-agent reservoir contains an electrolytic-agent solution in which a quantity of undissolved is disposed to keep the electrolytic-agent solution saturated as solvent diffuses into it.

### BACKGROUND OF THE INVENTION

1. Field of the Invention

The present invention concerns ionic-activity sensors, particularly of the flowing-electrolyte type.

2. Background Information

A basis of ionic-activity (electrochemical) measurements, including, for example, measurements of oxidation-reduction potential and of ionic-concentration such as pH, is the development of a potential difference across a membrane of a specific composition interposed between different solutions. In the case of pH measurements, for example, one measures the development of a potential gradient across a membrane when the sensor is interposed between solutions having different hydrogen-ion activities. In this example, the potential developed across the membrane is quantitatively related to the activity gradient of hydrogen ion and can be applied to a known measuring circuit to measure the pH of the sample. Because the potential developed across the glass is measured, electrolytic contacts must be made to the solutions on either side of the membrane. The potentials generated by these contacts are manipulated using, for example, Ag/AgCl reference electrodes with controlled concentrations of potassium chloride (KCl) solution.

The conventional, external reference electrode has two components that contribute to the total potential measured across the cell: a thermodynamic potential and a liquid junction potential. The thermodynamic potential is derived from the electrochemical half-cell, whereas the liquid junction potential is derived from the difference in the ionic composition of the internal salt bridge electrolyte and the process solution being measured. For example, where the reference electrode half-cell reaction is:
Ag^{o}+Cl⁻→AgCl+e⁻ (eq. 1)
the potential generated may be fixed by: (1) controlling the concentration of chloride ion, that is, Cl³¹ , at a constant value; and (2) preventing interfering ions in the process solution from approaching the reference half-cell. In prior reference half cells, these conditions are typically achieved by filling the reference half cell with potassium chloride (KCl), often within an internal chamber, which is connected to a salt bridge using an internal porous barrier. In such electrodes, electrolytic contact between the salt bridge and the process solution is made via an external ceramic barrier, and the salt bridge is stationary or non-flowing. However, in this configuration both the liquid junction and the half-cell potential may be compromised during ingress of the process solution into the internal salt-bridge and reference half-cell solutions. Thus, accurate measurements require that cell voltage varies only with the concentration of the ion of interest, and that the reference electrode potential remain constant, unaffected by the composition of the process solution. In fact, it is known that the reference electrode is often the cause of poor results obtained from measurements with ion-selective electrodes. See, for example, Brezinski, D. P. Analytica Chimica Acta 1982, 134, 247-62; the contents of which are hereby incorporated by reference.

One way to halt the ingress of the process solution into the internal salt-bridge and reference half-cell solutions is to have a reference solution flowing through the interface with the solution to be measured, as is described in U.S. Patent Application Ser. No. 2003/0178305; the contents of which are hereby incorporated by reference. As described therein, the source of this flowing reference solution can be incorporated directly into the sensor, or it can be external to the device. In any event, the flow rate needed to impede the ingress of the process solution into the sensor can be quite small, so the flowing-electrolyte design is quite a practical approach to extending pH-sensor life.

### SUMMARY

We have developed an advantageous approach to driving the electrolyte solution past a reference electrode in such a sensor. In accordance with our approach, the mechanism that drives the electrolyte solution is an osmotic pump.

In a typical embodiment, the osmotic pump will include a solvent reservoir containing a solvent, an osmotic-agent reservoir that contains an osmotic agent and is disposed in fluid communication with the solvent reservoir through a diffusion path, a semi-permeable osmotic membrane interposed in the diffusion path, and an actuator so operatively coupled to the osmotic-agent reservoir and the flowing electrolyte as to be urged by expansion of the osmotic-agent reservoir to drive the reference-cell electrolyte through the reference half cell's external junction. The semi-permeable osmotic membrane is more permeable to diffusion of the solvent than to the osmotic agent, so flow from the solvent side to the osmotic-agent side tends to predominate, thereby increasing the volume of osmotic-agent solution and resulting in the actuator's driving the electrolyte.

It turns out that an osmotic pump is particularly advantageous in this context, because it lends itself naturally to being implemented in embodiments whose flow-rate change throughout the sensor's lifetime is, for a given temperature, minimal. Specifically, the osmotic-agent reservoirs is a typical embodiment of this type will include a quantity of undissolved osmotic agent disposed in the osmotic-agent solution to keep that solution saturated. If, as it typical, the membrane is so impermeable to the electrolytic agent that diffusion of that agent into the solvent reservoir is negligible, this keeps the diffusion-rate-determining concentration difference across the membrane constant, so the resultant electrolyte flow is constant, too.

Such embodiments have the advantage that they can be made relatively small and long-lasting; if the flow rate that they maintain is not much greater than the minimum required to achieve the desired contamination prevention, the initial charge of electrolyte solution for a given lifespan tends to be smaller than it would have to be if, for example, the flow rate decreased with age and the initial rate therefore had to be relatively high. Moreover, although temperature changes do tend to change the resultant flow rate, those temperature changes can actually be beneficial, because they tend to compensate for the temperature-caused changes in the rate of contaminant diffusion. And osmotic pumps lend themselves particularly to providing the very low flow rates that are best for flowing electrolytes.

Some embodiments will have one or more of the following features. As was stated above, the flow of the electrolyte from the delivery fluid reservoir will be relatively constant in some. The flow rate of the electrolyte from the delivery fluid reservoir can be about 24 μL to about 36 μL per day; it may be 1 μL per hour, for example.

Sensors disclosed herein may be used to measure various types of ionic activity. In certain embodiments, the sensor is an oxidation reduction potential (ORP) sensor (with, for example a platinum electrode in the measuring half-cell) or an ion sensitive electrode (ISE) sensor (to sense, for example, fluoride).

A particularly important use is as a pH sensor. In such sensors, the pH glass may comprise about 33 to about 36 mole percent Li₂O, about 0.5 to about 1.5 mole percent of at least one oxide selected from the group consisting of Cs₂O and Rb₂O, about 4 to about 6 mole percent of a lanthanoid oxide, about 4 to about 6 mole percent of at least one oxide selected from the group consisting of Ta₂O₅ and Nb₂O₅, and about 54 to about 58 mole percent SiO₂. For example, the glass composition may comprise about 34 mole percent Li₂O, about 1.0 mole percent Cs₂O, about 5 mole percent La₂O₃, about 5 mole percent Ta₂O₅, and about 55 mole percent SiO₂ .

The pH glass membrane can have a thickness of about 0.01 inches to about 0.03 inches. In some embodiments, the pH glass membrane can have a substantially domed shape. In other embodiments, the pH glass membrane can have spherical or flat shape.

### BRIEF DESCRIPTION OF THE DRAWINGS

FIG. 1 is a cross-section of one embodiment of a sensor according to the present disclosure.

FIG. 2a is a cross-section of another embodiment of a sensor according to the present disclosure, taken along section line 2a-2a of FIG. 2b, and showing aspects of the resistance temperature device and the solution ground.

FIG. 2b is an end view of the embodiment depicted in FIG. 2a and depicts the sensing surface of the sensor.

FIG. 3a is a cross section of one embodiment of a sensor according to the present disclosure and depicts a solution ground that is substantially conical in shape.

FIG. 3b is a view of the embodiment depicted in FIG. 3a showing aspects of the temperature resistance device and a solution ground that is substantially conical in shape.

### DETAILED DESCRIPTION

The invention is applicable to devices that include a reference electrode for use with electrochemical ion measuring electrodes, for example, pH electrodes, and employ a flowing reference-cell electrolyte.

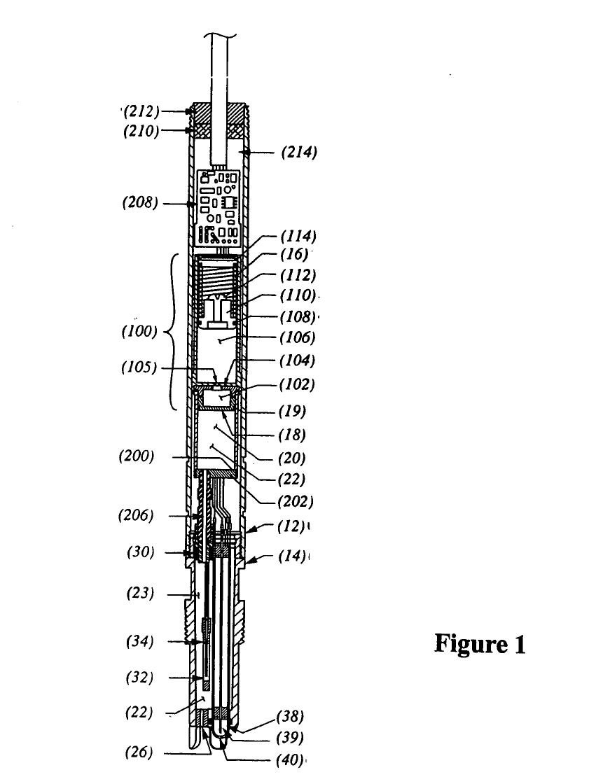

FIG. 1 depicts one such device. The FIG. 1 device, which is a pH sensor, includes an upper housing 12 and a lower housing 14. Located in the upper housing 12 is a delivery-fluid reservoir 20 for an electrolyte 22. As will be explained in due course, this electrolyte flows past a reference half cell 34. In the illustrated embodiment, the reference half cell 34's electrode is encased by an internal junction 32, which may be a cation-exchange membrane. The cation-exchange membrane may be a sulphonated polytetrafluoroethylene membrane, for example, commercially available membrane from DuPont under the trade name NAFION®. A glass membrane 40 surrounds the sensor's measuring electrode 39. A pre-amplifier board 208 receives the reference and measuring electrodes' outputs and in turn produces an output from which, as those skilled in the art will recognize, the test solution's pH can be inferred.

As was stated above, it is an osmotic pump that, in accordance with the invention, drives the electrolyte flow. In an osmotic pump, a semi-permeable membrane is interposed in a flow path between a solvent reservoir and an osmotic-agent reservoir. The membrane is more permeable to diffusion of the solvent reservoir's contents than to the osmotic agent reservoir's contents, so diffusion from the solvent reservoir into the osmotic-agent reservoir predominates. The osmotic-agent reservoir volume therefore increases and causes movement of an actuator, such as a flexible membrane or piston.

In the illustrated embodiment, for example, the osmotic pump 100 includes a semi-permeable membrane 104 disposed between a solvent reservoir 20 containing water and an osmotic-agent reservoir containing potassium chloride. In the illustrated embodiment, the membrane 104 is made of, for example, cellulose acetate, mixed cellulose esters, or polyamides (e.g. aromatic polyamides or aliphatic polyamines, such as nylon), all of which are orders of magnitude more permeable to water than they are to potassium chloride. So, since water concentration is greater on the membrane's solvent-reservoir side, diffusion from that side to its osmotic-agent-reservoir side predominates. The volume of the osmotic agent reservoir's contents must therefore increase, so they drive a delivery piston 18 against the electrolyte. This results in the desired electrolyte flow past the reference electrode 34 and through the external junction 26: the flowing electrolyte, as desired, acts as at least a portion of a salt bridge between the reference half cell and the solution to be measured. In certain embodiments the thickness of the osmotic membrane 104 is about 0.011 inches. In other embodiments the thickness of the osmotic membrane 104 is about 0.022 inches. In yet other embodiments the thickness of the osmotic membrane 104 is about 0.033 inches.

The cross-sectional area of the exposed membrane 104 controls the rate of flow of the drive fluid, which in turn controls the expansion of the osmotic agent against the delivery piston 18, causing the electrolyte 22 to flow from the delivery reservoir 20, through the fluid connection 206, and out the porous junction 26, thereby decreasing or preventing ingress of the sample solution.

In certain embodiments, such as the example presented in FIG. 1, a flow limiter 105 is placed between the osmotic membrane 102 and either the solvent reservoir 106 (as shown) or the osmotic agent reservoir 102. This flow limiter is impermeable to the solvent and thereby reduces the amount of osmotic membrane which comes in contact with the solvent or the osmotic agent solution, and can be used to control the rate of osmosis. In certain embodiments this flow limiter 105 has a diameter between about 0.01 inches and about 0.1 inches; about 0.03 inches and about 0.06 inches; or about 0.042 inches. In certain embodiments this flow limiter 105 has an area between about 3×10⁻⁴ in² to 6×10⁻⁴ in²; about 3×10⁻³ in² to 6×10⁻³ in²; or about 4.5×10₋₃ in². In certain embodiments the area defined by the opening of the flow limiter 105 is substantial circular.

In certain embodiments a volume-compensation mechanism is also provided to keep the drive fluid in contact with the semi-permeable membrane over the operating range of the pump. In one embodiment the volume-compensation may be a reservoir filled with a compressible fluid or a compressed gas to maintain the solvent in contact with the semi-permeable membrane. In other embodiments, a resilient mechanical member, such as FIG. 1's snap ring 114, spring 16, self sealing screw 112, and o-ring 108 may be used to allow for the drive fluid's expansion. In yet another embodiment, a chemical actuating device may be used.

Although it is possible to implement the present invention's teachings in such a way as to result in a flow rate that changes significantly, the illustrated embodiment is arranged for substantially constant flow. To appreciate this, it helps first to understand that this embodiment's membrane is so impermeable to the potassium chloride in the osmotic-agent reservoir that potassium chloride's diffusion into the solvent reservoir is negligible, so the water concentration in the solvent reservoir remains essentially constant. Of course, diffusion depends not on absolute concentration but rather on concentration difference, so, even though the concentration in the solvent reservoir does not change appreciably, the flow of water into the osmotic-agent reservoir could cause that reservoir's water concentration to increase and thereby reduce the concentration difference and the consequent rate of the electrolyte-flow-causing diffusion.

But the illustrated embodiment is arranged to prevent that. Specifically, the osmotic-agent reservoir includes undissolved potassium chloride in equilibrium with the dissolved potassium chloride. The quantity is great enough to keep the osmotic agent solution saturated even after all or nearly all of the solvent reservoir's contents have diffused through the osmotic membrane into the osmotic-agent reservoir: the concentration remains essentially constant for a given temperature. As described in, for example, Theeuwes, F. et al. (Annals of Biomedical Engineering 1976, 4, 343-353), this simple expedient can be used to maintain a substantially constant rate of diffusion. An osmotic pump can thereby be arranged to maintain the desired minimum electrolyte-flow rate so long as the solvent reservoir's contents last. And, since the flow rate never greatly exceeds the minimum necessary to avoid reference-cell contamination, the solvent-reservoir size required for a given sensor life can be relatively small.

The effectiveness of an approximately 1 μL/hr flow rate to prevent inward diffusion was demonstrated experimentally. So an internal fluid capacity is 8 mL can yield a useful life of one year. In some cases, the flow rate may be limited to less than about 24 μL/day. In another embodiment, the flow rate may be limited to less than about 1 μL/hour

In certain embodiments, the osmotic pump may be located outside the housing that contains the reference and measurement half-cells. One advantage to such an external pump would be the ability to replace or refill the pump.

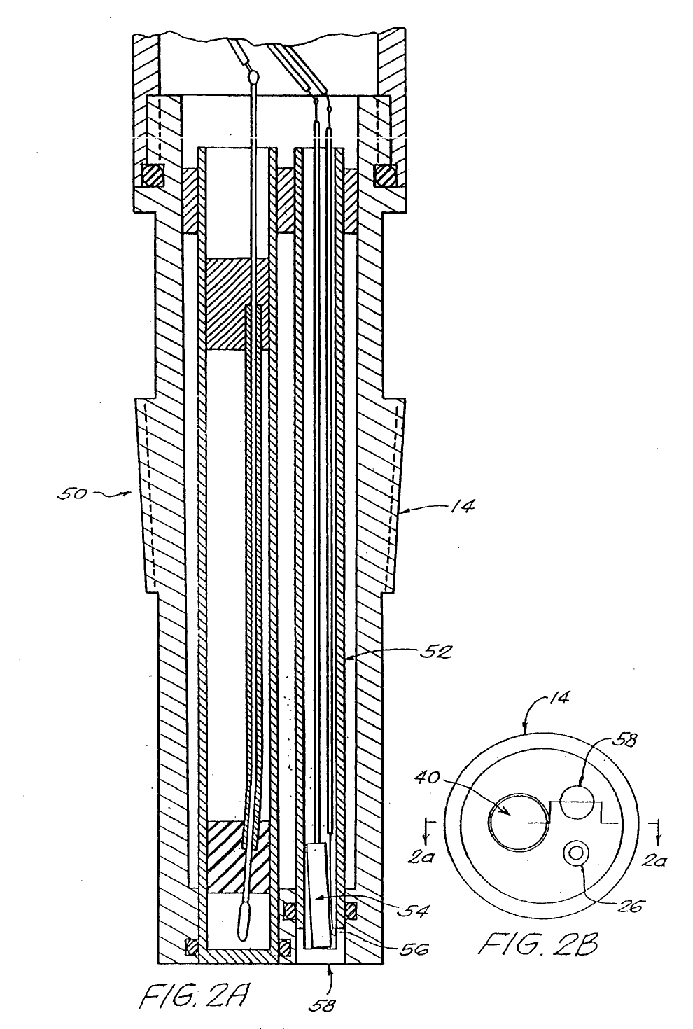

FIGS. 2a and 2b show a sensor 50 that includes a resistance temperature device 54. As shown in the illustrated embodiment, ground wire 56 is operatively connected to solution ground 58. In one embodiment, solution ground 58 is made of a non-metallic material. The solution ground 58 may be made of a conductive polymer, such as conductive polyvinyldifluoride, sold by Elf Atochem, N.A. under the trade name KYNAR®. The solution ground 58 may be bonded to insulating ground tube 52.

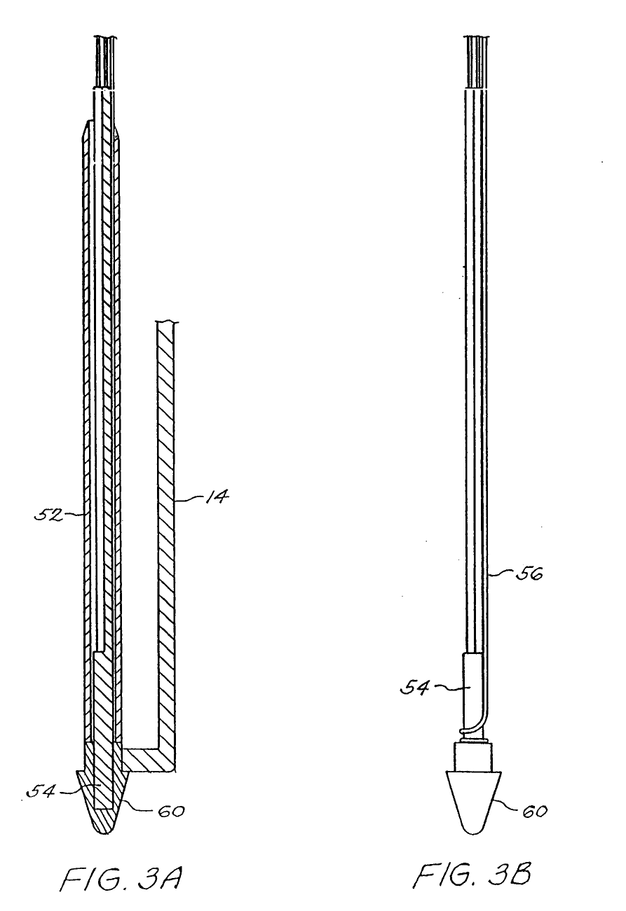

FIGS. 3a and 3b show another sensor which includes a substantially conical non-metallic ground 60. As further shown in the illustrated embodiment, the substantially conical non-metallic ground 60 may extend beyond the end of lower housing 14. The resistance temperature device 54 may extend into the substantially conical non-metallic ground 60, which is bonded to ground tube 52. FIG. 3b illustrates ground wire 56 in operative connection with the resistance temperature device 54.

The disclosure provides a sensor 50 having a non-metallic ground 58 positioned to contact a process solution. The ground 58 may be disposed at a sensing surface of the sensor, for example, any surface which is in contact with the process solution. In some embodiments, the non-metallic ground 58 may be an electrically conductive polymer. The non-metallic ground 58 may be made of polyvinyldifluoride, for example, such as that commercially available from Elf Atochem, N.A. under the trade name KYNAR®. A non-metallic ground of electrically conductive polymer can be bonded to a non-conductive polymer tube 52, which may provide an optimal thermal contact.

The disclosure provides a sensor having a resistance temperature device 54 that is bonded to a non-metallic ground 58. The disclosure also provides a method of manufacturing a sensor 50 having a resistance temperature device 54 bonded to a non-metallic ground 58. The method includes melting the non-metallic ground 58 in contact with the temperature device 54 and allowing the non-metallic ground 58 to solidify in contact with the device 54. The geometrical shape of the non-metallic ground 58 is not particularly limited. In one embodiment, the non-metallic ground extends beyond the end of the lower housing 14 and can additionally and/or optionally be substantially conical in shape.

In the illustrated embodiment, the sensor includes an internal or reference junction 32 that includes a cation exchange membrane. The cation exchange membrane may be a sulphonated polytetrafluoroethylene membrane, such as, for example, a commercially available membrane from DuPont under the trade name NAFION®. In one embodiment, a cation exchange membrane, for example, a membrane that is permeable to many cations and polar molecules, may be used as a material for a reference junction due in part to its ability to pass charge as positively charged cations. The cation exchange membrane may likewise be substantially impermeable to anions and non-polar species.

In one embodiment, a cation exchange membrane encases the reference electrode 34. Encasing the reference electrode 34 in a cation exchange membrane may serve to maintain the chloride level, for example, and reduce effects of contamination from external sources. The cation exchange membrane may also maintain the Ag⁺ level, for example, due to the fact that Ag⁺ forms a negatively charged complex of the form Ag(Clₙ)⁻⁽ⁿ⁻¹⁾. This may also inhibit the AgCl from reaching the external junction 26, where decreased KCl levels due to diffusion of the external process may result in the precipitation of AgCl. Such precipitation may cause clogging of the junction and a resulting noisy liquid junction potential. The reference electrode may include a seal 30. The seal may comprise a silicone based material.

For a sensor which uses, for example, AgCl-saturated, 1 M KCl electrolyte solution 22, the cation exchange membrane may be prepared by immersion in a solution of 1 M KCI. This process may create an electrical junction across the membrane, wherein potassium ions associate with the membrane. In operation, when a charge is drawn from an attached measuring device, potassium ions from the internal solution associate with the membrane, causing potassium ions to dissociate from the other side of the membrane. In contrast, conventional porous ceramic junctions may require negative ion movement in the opposite direction to maintain charge balance. Thus, while the flowing electrolyte 22 reduces back diffusion of contaminants through the external junction 26, even if contaminants were to reach this membrane, there would be little effect on the reference potential until the concentration builds to an appreciable fraction of the relatively high cation, for example, the K⁺ concentration.

As the illustrated embodiments show, the reference electrode 34 may be isolated from the process by at least an external liquid junction. As discussed herein, the external junction 26 may be a relatively low porosity ceramic, for example, an alumina ceramic. In other embodiments the external junction 26 may be wood or plastic (such as porous teflon).

In industrial applications, temperature cycling of the process may produce process solution thermal pumping into, and electrolyte solution thermal pumping out of, the reference solution chamber, through the external barrier 26. This phenomenon may shorten useful cell life by creating unstable junction potentials, and through loss of electrolyte 22. This effect can be reduced by using a higher flow restrictor such as micro porous VYCOR® glass 24 (e.g., Corning Glass code 7930). This micro porous glass 24 can be disposed between the reference electrode 34 and the external junction 26 to reduce the amount of fluid that may otherwise pass through the more porous ceramic frit 26, while maintaining electrical resistance less than or equal to about 20 kΩ.

A variety of reference electrodes and electrolytes are known and may be used with the disclosed sensors. An ordinarily skilled artisan can select an electrode/electrolyte combination for a particular application without undue experimentation. An example pH sensor may, for example, include a Ag/AgCl, 1 M KCl, Sat AgCl reference electrode that is isolated from the process by an external junction and an internal reference junction which includes a NAFION® membrane barrier. A positive outflow of electrolyte may counteract inward diffusion of process and additionally may inhibit clogging of the external junction by the process solution. The diffusional transport of process solution to the reference junction may be further restricted by a relatively long path length between the external and reference junctions.

The reference electrode 34 can produce and maintain a substantially constant or non-polarizable electromotive potential that is unaffected by the small electrical current requirement of the measuring device to which it is connected. Further, the reference electrode may maintain its stability over an entire temperature and pressure range requested and should be protected from exposure to the various chemical species in the large variety of processes in which these sensors are applied.

Silver and silver chloride, in contact with a fixed concentration of KCl, may be used for a pH sensor. When properly constructed, its potential may be non-polarizable at the current densities employed and its temperature dependence closely obeys theoretical predictions. At equilibrium, the following electrochemical reaction fixes the electrode potential:
AgCl+e⁻→Ag^{o}+Cl⁻ (eq. 2)

Silver chloride deposited on a silver wire may provide the reference terminal. When current is drawn through the cell, this reaction can proceed either to the right or left depending on current direction. The potential will remain constant as long as sufficient AgCl remains on wire, the chloride concentration remains constant and extraneous ionic species do not approach the proximity of the electrode and compete with the chloride ion.

Silver chloride solubility is related to concentration of KCl used in the salt bridge. The solubility of AgCl in 0, 1, 2, 3, and 4 M KCl is 0.01, 0.1, 0.6 2.2, and 8.0 mM, respectively. The increase in solubility is due to formation of negatively charged complex ions having the general formula Ag(Clₙ)⁻⁽ⁿ⁻¹⁾. Use of electrolyte 22 having high concentration of KCl is desirable for limiting electrical resistance over the path that isolates the internal reference junction 32 physically from the process. Also, the ability of KCl to form relatively clean junctions with the process samples with relatively small electrical junction potentials is desirable. However, when the concentration of KCl is diluted in the porous junction, AgCl precipitates and clogs it, causing spurious and erratic liquid junction potentials. Thus, a 1 M KCl solution is preferable because, at this concentration, the solubility of AgCl is roughly 1% of that in 4 M KCl.

If desired, the electrolyte used may contain an anti-freeze compound, such as a glycol, to provide freeze protection. For example, the electrolyte used may be 0.33 M KCl with 40 vol. % ethylene glycol, or 1 M KCl with 25% propylene glycol. NAFION® membrane resistance may vary significantly with degree of hydration and it is therefore necessary to condition the membrane in the electrolyte. This may be done by heating the NAFION membrane in the electrolyte for about one hour at about 95 to 100 ° C. The membrane may then be stored in a closed container of this electrolyte until used.

By using a osmotic pump, the benefits of a flowing-electrolyte sensor can be achieve in a way that is simple and inexpensive. The present invention therefore constitutes a significant advance in the art.

We claim:

1. An ion-activity sensor comprising:
A) reference and measurement half cells arranged for coupling to a solution to be measured, the coupling of the reference half cell being provided by a coupling path extending between the reference half cell and an external junction for exposure to the solution to be measured, wherein the coupling path includes a reference-cell electrolyte;
B) a measurement circuit, electrically coupled to receive the reference and measurement half cells″outputs, for generating a sensor output that indicates an ionic activity of the solution to be measured, and
C) an osmotic pump that drives the reference-cell electrolyte through the reference half cell's external junction.

2. The ion-activity sensor of claim 1, wherein the ionic activity indicated by the sensor output is oxidation/reduction potential.

3. The ion-activity sensor of claim 1, wherein the ionic activity indicated by the sensor output is ionic concentration.

4. The ion-activity sensor of claim 3, wherein the ionic concentration indicated by the sensor output is hydrogen concentration.

5. The ion-activity sensor of claim 3, wherein the ionic concentration indicated by the sensor output is fluoride concentration.

6. A pH sensor comprising:
A) reference and measurement half cells arranged for coupling to a solution to be measured, the coupling of the reference half cell being provided by a coupling path extending between the reference half cell and an external junction for exposure to the solution to be measured, wherein the coupling path includes a reference-cell electrolyte;
B) a measurement circuit, electrically coupled to receive the reference and measurement half cells' outputs, for generating a sensor output that indicates the pH of the solution to be measured, and
C) an osmotic pump that drives the reference-cell electrolyte through the reference half cell's external junction; wherein the osmotic pump includes:
i) a solvent reservoir containing a solvent;
ii) an osmotic-agent reservoir containing an osmotic agent and disposed in fluid communication with the solvent reservoir through a diffusion path;
iii) a semi-permeable membrane interposed in the diffusion path, the semi-permeable osmotic membrane being more permeable to diffusion of the solvent than to the osmotic agent; and
iv) iv)an actuator so operatively coupled to the osmotic-agent reservoir and the flowing electrolyte as to be urged by expansion of the osmotic-agent reservoir to drive the reference-cell electrolyte through the reference half cell's external junction.

7. A pH sensor as defined in claim 6 wherein the osmotic reservoir further comprises dissolved osmotic agent and a quantity of undissolved osmotic agent so disposed therein as to keep the osmotic agent solution saturated as solvent diffuses into the osmotic-agent reservoir.

8. A pH sensor as defined in claim 6 wherein said external junction comprises an alumina ceramic.

9. A pH sensor as defined in claim 6 wherein said measurement half cell further comprises a pH glass membrane.

10. A pH sensor as defined in claim 9 wherein said pH glass membrane has a substantially dome shape.

11. A pH sensor as defined in claim 9 wherein said pH glass membrane comprises a glass composition comprising about 33 to about 36 mole percent Li₂O, about 0.5 to about 1.5 mole percent of at least one oxide selected from the group consisting of Cs₂O and Rb₂O, about 4 to about 6 mole percent of a lanthanoid oxide, about 4 to about 6 mole percent of at least one oxide selected from the group consisting of Ta₂O₅ and Nb₂O₅, and about 54 to about 58 mole percent SiO₂.

12. A pH sensor as defined in claim 6 wherein said actuator is a piston.

13. A pH sensor as defined in claim 6 wherein said osmotic agent is an alkali or alkali earth metal halide.

14. A pH sensor as defined in claim 6 wherein said osmotic agent is sodium chloride or potassium chloride.

15. A pH sensor as defined in claim 6 wherein said electrolyte comprises potassium chloride.

16. A pH sensor as defined in claim 6 wherein said electrolyte comprises potassium chloride and one or more components selected from the group consisting of ethylene glycol, propylene glycol, sodium chloride and silver nitrate.

17. A pH sensor as defined in claim 6 wherein the reference-cell electrolyte flows through the reference half cell's external junction at a rate of about 24 μL per day.

18. A pH sensor as defined in claim 6 wherein the reference-cell electrolyte flows through the reference half cell's external junction at a rate of about 1 μL per hour.

19. A pH sensor as defined in claim 6 wherein said semi-permeable osmotic membrane consists essentially of a material selected from the group consisting of cellulose acetate, aromatic polyamides, aliphatic polyamines, or a mixture thereof.

20. A pH sensor as defined in claim 6 wherein said semi-permeable osmotic membrane consists essentially of cellulose acetate or an aromatic polyamide.
